(19) United States
(12) Patent Application Publication
(10) Pub. No.: US 2002/0133719 A1
(43) Pub. Date: Sep. 19, 2002

(54) Method and apparatus for sharing authentication information between multiple servers

(76) Inventor: Jay Westerdal, Bellevue, WA (US)

Correspondence Address: PARK, VAUGHAN & FLEMING LLP, 508 SECOND STREET, SUITE 201, DAVIS, CA, 95616, US

(21) Appl. No.: 09/809,539

(22) Filed: Mar. 14, 2001

(51) Int. Cl. H04L 9/32

(52) U.S. Cl. 713/201

(57) ABSTRACT

One embodiment of the present invention provides a system that facilitates sharing authentication information between a plurality of servers within a distributed computing system. Upon receiving a communication from a client at a first server, the system determines whether the client is known to the first server. If the client is unknown to the first server, the first server generates a first identifier for the client, and then communicates this first identifier to the client. The first server also directs the client to communicate the first identifier to the authentication server, so that the authentication server can attempt to associate the first identifier with a known client.

### BACKGROUND

1. Field of the Invention

The present invention relates to providing security in distributed computing systems. More specifically, the present invention relates to a method and an apparatus that facilitates sharing authentication information between multiple independent servers within a distributed computing system.

2. Related Art

A typical Internet user visits a web site multiple times in order to gather information or perform transactions. During this process, it is often useful for the web site to be able to identify the user, so that the web site can remember what the user did during the previous visit. This allows the web site to tailor web pages for the user.

In order to facilitate identification of the user, a web server often sends a special message called a “cookie” to the web browser. The browser stores this cookie in a file called “cookie.txt”. Each time the browser subsequently requests a web page from the server, the browser sends the cookie back to the server along with the request. By examining the cookie, the web site can identify the user, which enables the web site to look up information on the user and to prepare web pages that are customized for the user.

Unfortunately, cookies are not designed to traverse multiple domains. Hence, a cookie that is configured to identify a user to a website located in a first domain will not be presented to another web site located in a second domain. This makes it hard for a set of related web sites to share information regarding a web user. Hence, the web user may have to re-enter information, such as a home address or a password, for each web site the user visits, even if the web sites are related to each other.

In order to alleviate this problem, some organizations have changed the name of their web sites to all reside under one domain name. For example, “domain1.com” and “domain2.com” can be changed to “domain1.maindomain.com” and “domain2.maindomain.com”, respectively. Unfortuantely, locating a set of related web sites under a single domain can decrease the visibility of the web sites to search engines that attempt to locate web sites containing specific information. This can lead to less traffic through the set of related web sites.

Hence, what is needed is a method and an apparatus for using cookie information to identify a web user across multiple web sites located under different domain names.

### SUMMARY

One embodiment of the present invention provides a system that facilitates sharing authentication information between a plurality of servers within a distributed computing system. Upon receiving a communication from a client at a first server, the system determines whether the client is known to the first server. If the client is unknown to the first server, the first server generates a first identifier for the client, and then communicates this first identifier to the client. The first server also directs the client to communicate the first identifier to the authentication server, so that the authentication server can attempt to associate the first identifier with a known client.

In one embodiment of the present invention, if the client is known to the authentication server, the authentication server associates the first identifier with a pre-existing identifier for the client.

In one embodiment of the present invention, if the client is unknown to the authentication server, the authentication server causes the client to store a cookie for the authentication server. This cookie contains an identifier for the client, so that the authentication server can subsequently identify the client by examining the cookie.

In one embodiment of the present invention, the authentication server determines whether or not the client is known to the authentication server by attempting to examine a cookie presented by the client to the authentication server.

In one embodiment of the present invention, if the client is unknown to the first server, the system additionally causes the client to store a cookie for the first server, so that the client can subsequently present the cookie to the first server in order to identify the client to the first server.

In one embodiment of the present invention, upon subsequently receiving a username and a password from the client, the system attempts to authenticate the client based on the username and the password. If the client is successfully authenticated, the system associates the username with the client.

In one embodiment of the present invention, the system determines whether the client is known to the first server by looking for a cookie presented by the client to the first server. If such a cookie is presented by the client, the system determines if the cookie contains an identifier that is known to the first server.

### BRIEF DESCRIPTION OF THE FIGURES

FIG. 1 illustrates a distributed computing system in accordance with an embodiment of the present invention.

FIG. 2 is a flow chart illustrating the process of directing a client to an authentication server in accordance with an embodiment of the present invention.

FIG. 3 is a flow chart illustrating the process of associating a client with an authentication server cookie in accordance with an embodiment of the present invention.

FIG. 4 is a flow chart illustrating the process of authenticating a user at a server in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Distributed Computing System

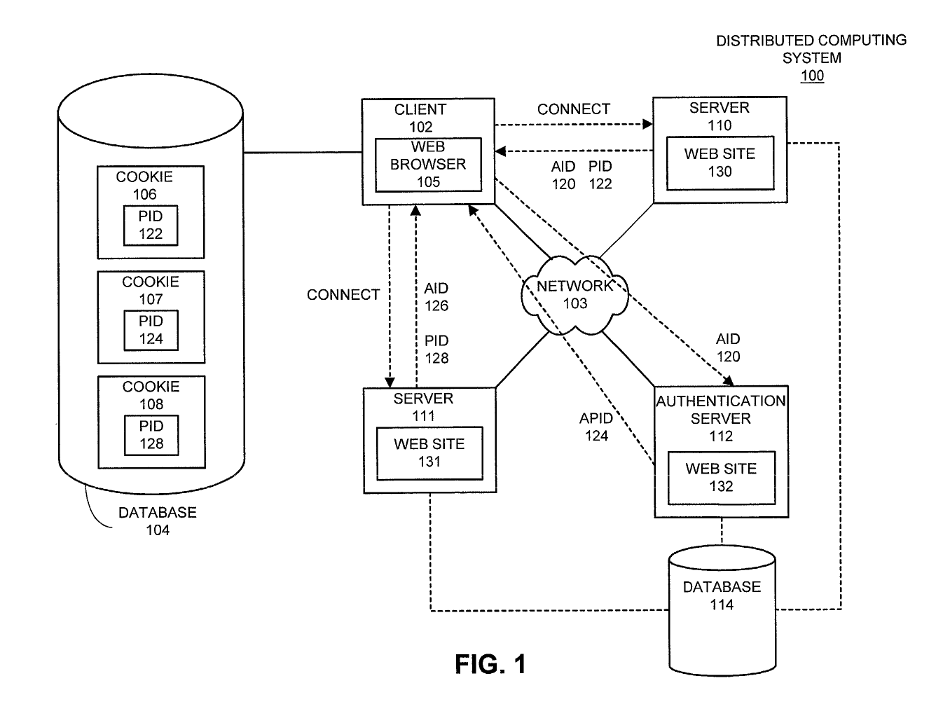

FIG. 1 illustrates a distributed computing system 100 in accordance with an embodiment of the present invention. Distributed computing system 100 includes a client 102 coupled to servers 110-111 and authentication server 112 through network 103.

Network 103 can generally include any type of wire or wireless communication channel capable of coupling together computing nodes. This includes, but is not limited to, a local area network, a wide area network, or a combination of networks. In one embodiment of the present invention, network 103 includes the Internet.

Client 102, servers 110-111 and authentication server 112 are computer systems that can generally include any type of computer system, including, but not limited to, a computer system based on a microprocessor, a mainframe computer, a digital signal processor, a portable computing device, a personal organizer, a device controller, and a computational engine within an appliance.

More specifically, servers 110-111 and authentication server 112 are servers that can generally include any nodes on network 103 including a mechanism for servicing requests from client 102 for computational and/or data storage resources. Servers 110-112 contains web sites 130-132, respectively, which contain inter-linked pages of textual and graphical information that can be navigated through by using web browser 105 located on client 102.

Servers 110-112 are in communication with database 114, which can be used to share data between servers 110-112. Database 114 can include any type of system for storing data in non-volatile storage. This includes, but is not limited to, systems based upon magnetic, optical, and magneto-optical storage devices, as well as storage devices based on flash memory and/or battery-backed up memory. Note that database 114 can be a distributed database, or alternatively a centralized database located on a specific computing node.

Client 102 can generally include any node on network 103 including computational capability and including a mechanism for communicating across the network. Client 102 contains web browser 105, which can generally include any type of web browser capable of viewing a web site, such as the INTERNET EXPLORER™ browser distributed by the Microsoft Corporation of Redmond, Wash.

Web browser 105 makes use of a number of cookies 106-108 stored within database 104. Database 104 can include any type of system for storing data in non-volatile storage. This includes, but is not limited to, systems based upon magnetic, optical, and magneto-optical storage devices, as well as storage devices based on flash memory and/or battery-backed up memory. In one embodiment of the present invention, database 104 is a file system and cookies 106-108 are contained within individual files in the file system. Note that cookies 106, 107 and 108 contain identifiers 122, 124 and 128, respectively, which can be used to identify client 102 as the owner of cookies 106-108.

Process of Directing a Client to an Authentication Server

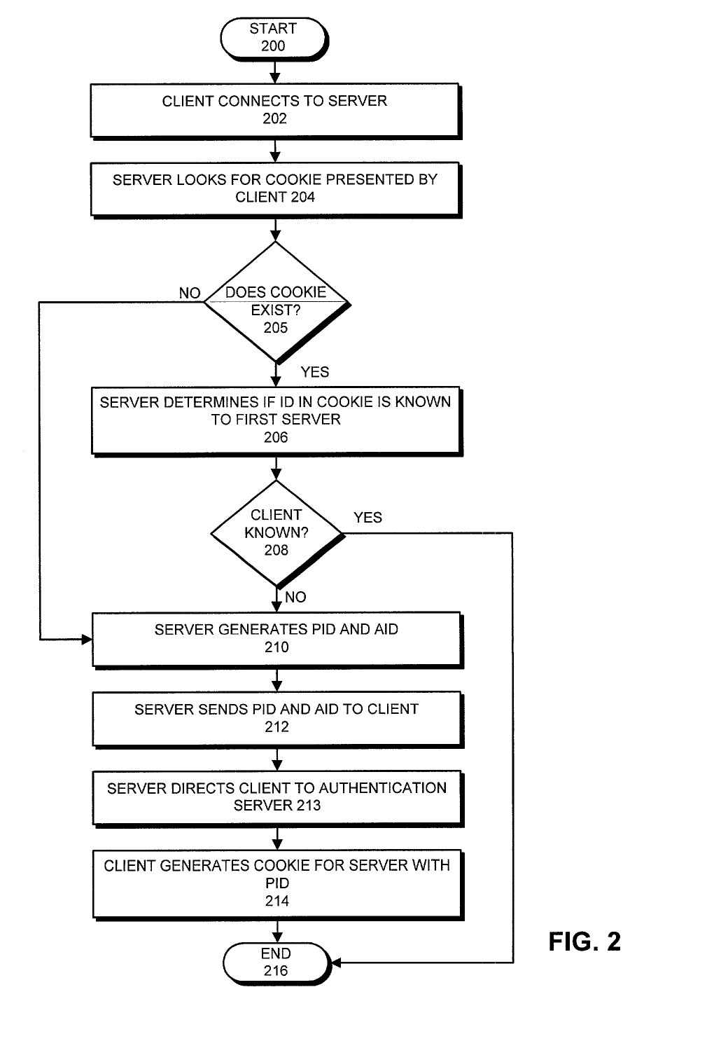

FIG. 2 is a flow chart illustrating the process of directing client 102 to authentication server 112 in accordance with an embodiment of the present invention. The system starts when client 102 first connects to server 110 (box 202). Next, server 110 looks for a cookie presented by web browser 105 to web site 130 on server 110 (box 204). If this cookie exists, server 110 determines if an identifier embedded within the cookie is known to server 110 (box 206). For example, if client 102 presents cookie 106 to server 110, server 110 checks to see if identifier (PID) 122 is known to server 110. If so, client 102 is known to server 110, and the process completes.

If at box 208, the identifier is not known to server 110, or if at box 205, no cookie was presented by client 102 to server 110, the system generates an authentication identifier AID 120 and identifier (PID) 122 (box 210) for client 102, and sends AID 120 and PID 122 to client 102 (box 212). Server 110 also directs client 102 to authentication server 112 (box 213). This is accomplished by communicating a script tag to client 102 that has its source in authentication server 112.

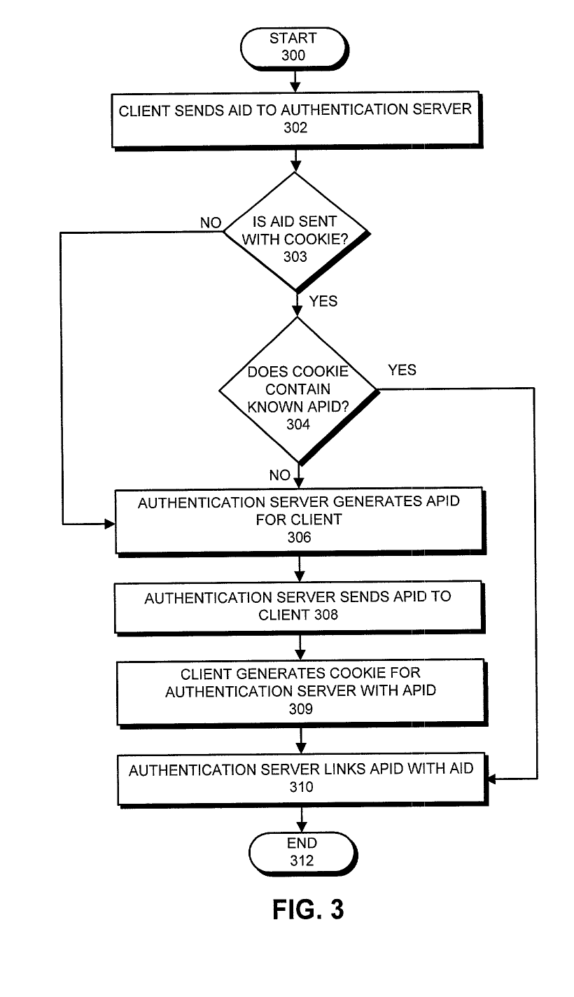

At this point, client 102 generates a cookie 106 for server 110 and embeds PID 122 into cookie 106 (box 214). Client 102 then sends AID 120 to authentication server 110 as is described in more detail below with reference to FIG. 3.

Process of Associating a Client with and Authentication Server Cookie

FIG. 3 is a flow chart illustrating the process of associating client 102 with an authentication server cookie 107 in accordance with an embodiment of the present invention. The system starts when client 102 sends AID 120 to authentication server 112 (box 302). In one embodiment of the present invention, this takes place when client 102 retrieves a script for authentication server 112 that was communicated to client 102 by server 110.

Next, authentication server 112 determines if a cookie for authentication server 112 is sent to authentication server 112 along with AID 120 (box 303). If so, authentication server 112 determines if the cookie contains a known authentication server identifier (APID) 124. For example, authentication server 112 can check APID 124 in cookie 107 that is presented to authentication server 112 by client 102 along with AID 120. If cookie 107 contains a known APID 124, then client 102 is known to authentication server 112. At this point, authentication server 112 links APID 124 for client 102 with AID 120 (box 310). This allows server 110 to know the identity of client 102.

If at box 303, no cookie is sent along with AID 120, or if at box 304, APID 124 is not known to authentication server 112, authentication server 112 generates a new APID 124 for client 102 (box 306). Next, authentication server 112 sends the new APID 124 to client 102 (box 308). This allows client 102 to generate a new cookie 107 for authentication server 112 containing APID 124 (box 309). This causes client 102 to send cookie 107 to authentication server 112 along with subsequent page requests. At this point, authentication server 112 links APID 124 for client 102 with AID 120 (box 310), which allows server 110 to know the identity of client 102.

Process of Authenticating a User at a Server

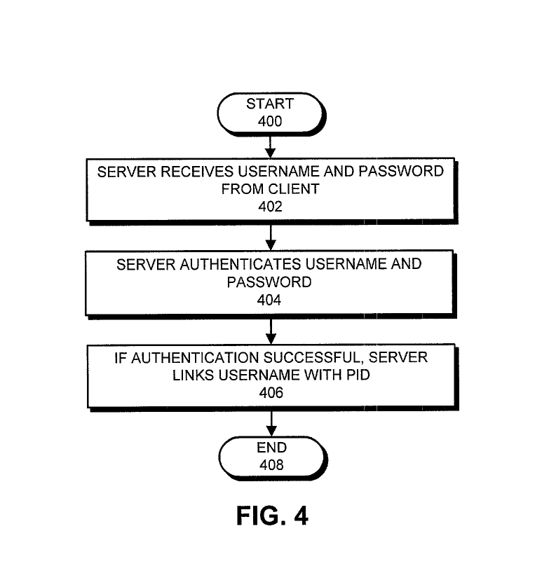

FIG. 4 is a flow chart illustrating the process of authenticating a user at a server 110 in accordance with an embodiment of the present invention. The system starts when server 110 receives a username and a password from a user of client 102 (box 402). Note that client 102 has been previously identified through the process outlined in FIGS. 2 and 3 above. Server 110 then authenticates the username and password (box 404). If this authentication is successful, server 110 links the username with the APID 124 of client 102 (box 406).

At this point, the username is associated with APID 124, which is presented by client 102 to authentication server 112 in subsequent communications with authentication server 112.

If client 102 subsequently communicates with a server 111, that does not know about client 102, server 111 will direct client 102 back to authentication server 112, which will create a link to the known APID 124 for client 102, and will thereby create a link to the username. At this point, server 111 knows that client 102 is authenticated without requiring the user to enter the username and password again.

Note that the authentication process outlined in FIG. 4 can take place at any server in distributed computing system 100 which knows about client 102, including server 110, server 111 and authentication server 112.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method that facilitates sharing authentication information between a plurality of servers within a distributed computing system, wherein the plurality of servers includes a first server and an authentication server, the method comprising:
receiving a communication from a client at the first server;
determining whether the client is known to the first server; and
if the client is unknown to the first server,
generating a first identifier for the client,
communicating the first identifier to the client, and
directing the client to communicate the first identifier to the authentication server, so that the authentication server can attempt to associate the first identifier with a known client.

2. The method of claim 1,
wherein if the client is known to the authentication server, the authentication server associates the first identifier with a pre-existing identifier for the client;
wherein if the client is unknown to the authentication server, the authentication server causes the client to store a cookie for the authentication server, wherein the cookie contains an identifier for the client, so that the authentication server can subsequently identify the client by examining the cookie.

3. The method of claim 1, wherein the authentication server determines whether or not the client is known to the authentication server by attempting to examine a cookie presented by the client to the authentication server.

4. The method of claim 1, wherein if the client is unknown to the first server, the method additionally comprises causing the client to store a cookie for the first server, so that the client can subsequently present the cookie to the first server in order to identify the client to the first server.

5. The method of claim 1, further comprising:
receiving a username and a password from the client;
attempting to authenticate the client based on the username and the password; and
if the client authenticates, associating the username with the client.

6. The method of claim 1, wherein determining whether the client is known to the first server involves:
looking for a cookie presented by the client to the first server; and
if such a cookie is presented by the client, determining if the cookie contains an identifier that is known to the first server.

7. A method that facilitates sharing authentication information between a plurality of servers within a distributed computing system, wherein the plurality of servers includes a first server and an authentication server, the method comprising:
receiving a communication from a client at the authentication server, wherein the communication includes a first identifier generated by the first server for the client;
determining whether the client is known to the authentication server;
if the client is known to the authentication server, associating the first identifier with a pre-existing identifier for the client; and
if the client is unknown to the authentication server, causing the client to store a cookie for the authentication server, wherein the cookie contains an identifier for the client, so that the authentication server can subsequently identify the client by examining the cookie.

8. The method of claim 7, wherein the authentication server determines whether or not the client is known to the authentication server by attempting to examine a cookie presented by the client to the authentication server.

9. The method of claim 7, further comprising:
receiving a username and a password from the client;
attempting to authenticate the client based on the username and the password; and
if the client authenticates, associating the username with the client.

10. A computer-readable storage medium storing instructions that when executed by a computer cause the computer to perform a method that facilitates sharing authentication information between a plurality of servers within a distributed computing system, wherein the plurality of servers includes a first server and an authentication server, the method comprising:
receiving a communication from a client at the first server;
determining whether the client is known to the first server; and
if the client is unknown to the first server,
generating a first identifier for the client,
communicating the first identifier to the client, and
directing the client to communicate the first identifier to the authentication server, so that the authentication server can attempt to associate the first identifier with a known client.

11. The computer-readable storage medium of claim 10,
wherein if the client is known to the authentication server, the authentication server associates the first identifier with a pre-existing identifier for the client;
wherein if the client is unknown to the authentication server, the authentication server causes the client to store a cookie for the authentication server, wherein the cookie contains an identifier for the client, so that the authentication server can subsequently identify the client by examining the cookie.

12. The computer-readable storage medium of claim 10, wherein the authentication server determines whether or not the client is known to the authentication server by attempting to examine a cookie presented by the client to the authentication server.

13. The computer-readable storage medium of claim 10, wherein if the client is unknown to the first server, the method additionally comprises causing the client to store a cookie for the first server, so that the client can subsequently present the cookie to the first server in order to identify the client to the first server.

14. The computer-readable storage medium of claim 10, wherein the method further comprises:
receiving a username and a password from the client;
attempting to authenticate the client based on the username and the password; and
if the client authenticates, associating the username with the client.

15. The computer-readable storage medium of claim 10, wherein determining whether the client is known to the first server involves:
looking for a cookie presented by the client to the first server; and
if such a cookie is presented by the client, determining if the cookie contains an identifier that is known to the first server.

16. A computer-readable storage medium storing instructions that when executed by a computer cause the computer to perform a method that facilitates sharing authentication information between a plurality of servers within a distributed computing system, wherein the plurality of servers includes a first server and an authentication server, the method comprising:
receiving a communication from a client at the authentication server, wherein the communication includes a first identifier generated by the first server for the client;
determining whether the client is known to the authentication server;
if the client is known to the authentication server, associating the first identifier with a pre-existing identifier for the client; and
if the client is unknown to the authentication server, causing the client to store a cookie for the authentication server, wherein the cookie contains an identifier for the client, so that the authentication server can subsequently identify the client by examining the cookie.

17. The computer-readable storage medium of claim 16, wherein the authentication server determines whether or not the client is known to the authentication server by attempting to examine a cookie presented by the client to the authentication server.

18. The computer-readable storage medium of claim 16, wherein the method further comprises:
receiving a username and a password from the client at the first server;
attempting to authenticate the client based on the username and the password; and
if the client authenticates, associating the username with the client.

19. An apparatus that facilitates sharing authentication information between a plurality of servers within a distributed computing system, the apparatus comprising:
a first server within the plurality of servers;
a receiving mechanism within the first server that is configured to receive a communication from a client; and
an identification mechanism within the first server that is configured to determine whether the client is known to the first server;
wherein if the client is unknown to the first server, the identification mechanism is configured to,
generate a first identifier for the client,
communicate the first identifier to the client, and to
direct the client to communicate the first identifier to the authentication server, so that the authentication server can attempt to associate the first identifier with a known client.

20. The apparatus of claim 19, further comprising
an authentication server within the plurality of servers;
an association mechanism within the authentication server;
wherein if the client is known to the authentication server, the association mechanism is configured to associate the first identifier with a pre-existing identifier for the client;
wherein if the client is unknown to the authentication server, the association mechanism is configured to cause the client to store a cookie for the authentication server, wherein the cookie contains an identifier for the client, so that the authentication server can subsequently identify the client by examining the cookie.

21. The apparatus of claim 20, wherein the authentication server additionally includes an identification mechanism that is configured to determine whether or not the client is known to the authentication server by attempting to examine a cookie presented by the client to the authentication server.

22. The apparatus of claim 19, wherein if the client is unknown to the first server, the identification mechanism is additionally configured to cause the client to store a cookie for the first server, so that the client can subsequently present the cookie to the first server in order to identify the client to the first server.

23. The apparatus of claim 19, further comprising an authentication mechanism that is configured to:
receive a username and a password from the client;
attempt to authenticate the client based on the username and the password; and to
associate the username with the client if the client authenticates.

24. The apparatus of claim 19, wherein the identification mechanism is configured to:
look for a cookie presented by the client to the first server; and
if such a cookie is presented by the client, to determine if the cookie contains an identifier that is known to the first server.

25. An apparatus that facilitates sharing authentication information between a plurality of servers within a distributed computing system, the apparatus comprising:
an authentication server within the plurality of servers;
a receiving mechanism within the authentication server that is configured to receive a communication from a client, wherein the communication includes a first identifier generated by a first server within the plurality of servers for the client;
an identification mechanism within the authentication server that is configured to determine whether the client is known to the authentication server; and
an association mechanism within the authentication server;
wherein if the client is known to the authentication server, the association mechanism is configured to associate the first identifier with a pre-existing identifier for the client;
wherein if the client is unknown to the authentication server, the association mechanism is configured to cause the client to store a cookie for the authentication server, wherein the cookie contains an identifier for the client, so that the authentication server can subsequently identify the client by examining the cookie.

26. The apparatus of claim 25, wherein the identification mechanism is configured to determine whether or not the client is known to the authentication server by attempting to examine a cookie presented by the client to the authentication server.

27. The apparatus of claim 25, further comprising an authentication mechanism that is configured to:
receive a username and a password from the client;
attempt to authenticate the client based on the username and the password; and to
associate the username with the client if the client authenticates.
